(19) United States
(12) Patent Application Publication
(10) Pub. No.: US 2026/0097553 A1
(43) Pub. Date: Apr. 9, 2026

(54) Additive Manufacturing Of Marine Mooring Chains

(71) Applicant: Chevron U.S.A. Inc., San Ramon, CA (US)

(72) Inventors: Wei Ma, Houston, TX (US); Robert Kwan Meng Seah, Cypress, TX (US); Xiaoyan Yan, Houston, TX (US)

(21) Appl. No.: 19/115,090

(22) PCT Filed: Oct. 3, 2023
(86) PCT No.: PCT/US2023/075851

§ 371 Date: Mar. 25, 2025

Related U.S. Application Data
(60) Provisional application No. 63/378,194, filed on Oct. 3, 2022.

(51) Int. Cl. B29C 64/10; B29C 64/336; B29L 31/12; B33Y 10/00; B33Y 80/00

(52) U.S. Cl. CPC B29C 64/10; B29C 64/336; B29L 2031/12; B33Y 10/00; B33Y 80/00

(57) ABSTRACT

Additive manufacturing techniques can be used to form marine mooring chains. In one example method, individual chain links are printed using additive manufacturing and then joined together to form a section of a marine mooring chain. In another example method, multiple chain links are printed together simultaneously to form a section of a marine mooring chain. The links of the marine mooring chain formed using additive manufacturing are advantageous in that selected materials and sensors can be embedded in the chain links and the links can be formed to have a functional gradient.

### RELATED APPLICATIONS

The present application claims priority to U.S. Provisional Patent Application No. 63/378,194 filed Oct. 3, 2022, the entire content of which is incorporated herein by reference.

### TECHNICAL FIELD

Embodiments of the technology relate to using additive manufacturing to form mooring chains for floating marine platforms.

### BACKGROUND

Floating drilling and production platforms used in the hydrocarbon industry are moored in place with mooring lines. Mooring lines typically are a combination of rope segments, which comprise wire or fiber rope, and steel chain segments comprising large steel chain links. Each of the large steel chain links can weigh up to several hundred pounds and can be up to a couple of feet tall. The steel chain segments are relatively more durable than rope segments against abrasion and wear and are used at the ends of the mooring line to attach to the floating platform at the water's surface and to an anchor on the seafloor. Once in place, mooring lines are often in place in the water for 20 or 30 years without being replaced.

The chain links are made from high strength steel bars through a series of steps that involve heating, bending, welding, and polishing. However, experience has shown that the steel chain segments are one of the more vulnerable components of the mooring line for several reasons. First, the bending of the steel bar in forming a chain link causes stress concentrations in the crown, shoulder, and inter-grip portions of the chain link. Second, once deployed, the chain links are subjected to storm and cyclic fatigue loads from vessel motions. Third, corrosion caused by seawater has been found to be an important contributor to the failure of mooring chains. Coatings, such as thermal sprayed aluminum, can be applied to the chain links to mitigate corrosion. However, such coatings typically have low resistance to wear and abrasion and typically only provide corrosion resistance for a few years. Furthermore, such coatings are typically expensive and require special handling.

### SUMMARY

The present application is generally directed to marine mooring chains formed by additive manufacturing methods. One example embodiment is directed to a marine mooring chain and a method of forming the marine mooring chain using an additive manufacturing process. The method can include: 1) forming, by the additive manufacturing process, a portion of a base of a first chain link; 2) turning over the portion of the base and placing one or more supports about the portion of the base; 3) forming, by the additive manufacturing process, a remainder of the base and a pair of arms of the first chain link, thereby producing a partial first chain link; 4) forming, by the additive manufacturing process, a portion of a crown; 5) turning over the portion of the crown and placing one or more supports about the portion of the crown; 6) forming, by the additive manufacturing process, a remainder of the crown and a pair of crown shoulders, thereby producing a crown assembly; 7) placing a previously completed chain link onto the partial first chain link; and 8) fusing the crown assembly onto the partial first chain link, thereby producing a pair of interlocked chain links of the marine mooring chain.

Another example embodiment is directed to a marine mooring chain and a method of forming the marine mooring chain using an additive manufacturing process. The method can include: 1) printing, with a robotic printer system, a base layer of a chain segment comprising multiple chain links, wherein the multiple chain links of the chain segment are interlocked and laying lengthwise on a platform, and wherein the base layer comprises a first material; 2) printing, with the robotic printer system, a second layer of the chain segment comprising multiple chain links, wherein the second layer comprises a second material; and 3) printing, with the robotic printer system, a third layer of the chain segment comprising multiple chain links, wherein the third layer comprises the first material.

Yet another example embodiment is directed to a marine mooring chain and a method of forming the marine mooring chain using an additive manufacturing process. The method can include: 1) forming, by the additive manufacturing process, a first portion of a chain link by depositing and fusing chain link material using a welding robot comprising a printing head; and 2) fusing a casting portion to the first portion of the chain link, the casting portion comprising at least one of a sensor and a sensor mounting point, wherein the first portion and the casting portion form the chain link.

The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments for additive manufacturing of marine mooring chains. Therefore, the examples provided are not to be considered limiting of the scope of this disclosure. The principles illustrated in the example embodiments of the drawings can be applied to alternate methods and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 illustrates a first step of a method for manufacturing a chain link in accordance with an example embodiment of the disclosure.

FIG. 2 illustrates a second step of the method for manufacturing a chain link in accordance with an example embodiment of the disclosure.

FIG. 3 illustrates a third step of the method for manufacturing a chain link in accordance with an example embodiment of the disclosure.

FIG. 4 illustrates a fourth step of the method for manufacturing a chain link in accordance with an example embodiment of the disclosure.

FIG. 5 illustrates a fifth step of the method for manufacturing a chain link in accordance with an example embodiment of the disclosure.

FIG. 6 illustrates a sixth step of the method for manufacturing a chain link in accordance with an example embodiment of the disclosure.

FIG. 7 illustrates a side view of a second method for manufacturing a segment of chain links in accordance with an example embodiment of the disclosure.

FIG. 8 illustrates a top view of the second method for manufacturing a segment of chain links in accordance with an example embodiment of the disclosure.

FIG. 9 illustrates another side view of the second method for manufacturing a segment of chain links in accordance with an example embodiment of the disclosure.

FIG. 10 illustrates a third method for manufacturing a chain link that includes a casting portion in accordance with an example embodiment of the disclosure.

### DETAILED DESCRIPTION OF EXAMPLE EMBODIMENTS

The example embodiments discussed herein are directed to improved marine mooring chains and methods for their manufacture. As explained above, the steel chain segments are one of the more vulnerable components of a marine mooring line. Failure of a marine mooring line can impact not only the floating platform that is being anchored by the mooring line, but also the complex drilling or production operations associated with a subsea well below the floating platform. Given the complexity of managing and maintaining floating platforms in harsh marine environments, techniques that improve the strength, durability, and corrosion resistance of the steel chain segments would be beneficial.

The conventional approaches to strengthening steel chain links simply add more material or coatings, which adds expense and weight and does not provide a long term solution. In contrast, additive manufacturing allows for more intelligent design in forming the steel chain links that make up a chain segment. Instead of the conventional approach of forming a chain link by heating and bending a straight steel bar, additive manufacturing involves forming a component by depositing repeated layers of material in the shape of the component and fusing the material together. The use of additive manufacturing to create marine mooring chains presents unique challenges and opportunities. The large size and weight of the chain links used in marine mooring chains makes the use of conventional additive manufacturing approaches challenging because the heavy chain links may need to be moved or supported as they are formed and unique techniques are needed for linking together heavy chain links.

With respect to opportunities, additive manufacturing allows for creating chain links that are customized to address the harsh environmental conditions in which mooring lines are deployed. Instead of being confined by the limitations of conventional approaches in which chain links are formed by bending a steel bar, additive manufacturing's layered assembly of materials provides advantages when applied to the large chain links used in mooring chains. Because additive manufacturing eliminates the need to bend steel bars into chain links, it may reduce the stress concentrations introduced by conventional manufacturing in the crown, shoulder, and inter-grip portions of conventional steel chain links.

Furthermore, additive manufacturing allows for the use of unique shapes and materials in creating durable chain links for marine mooring lines. As one example, the chain link can be made thicker in vulnerable areas such as the shoulder. Additive manufacturing also allows for a functional gradient wherein a cross-section of the chain link comprises different materials or has different properties along the cross-section. For instance, a functional gradient approach to additive manufacturing allows for the use of corrosion resistant materials at the outer surface of the chain link. As another example, different layers of material formed using additive manufacturing can have different physical properties, such as conductivity or color, that facilitate detection of the wearing away of one or more layers of material from the chain link. Such wear can be detected by a diver or a remotely operated vehicle using calipers, a camera, an ohmmeter, or other equipment. Furthermore, additive manufacturing allows for embedding sensors, such as a semi-conductor material or fiber optic components, within the chain link. As yet another example, additive manufacturing facilitates forming sensor mounting points, such as eyelets or flanges, on the chain link for subsequent attachment of sensors to the chain link.

While example embodiments for additive manufacturing of marine mooring chains are provided in the descriptions that follow, it should be understood that modifications to the embodiments described herein are within the scope of this disclosure. In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

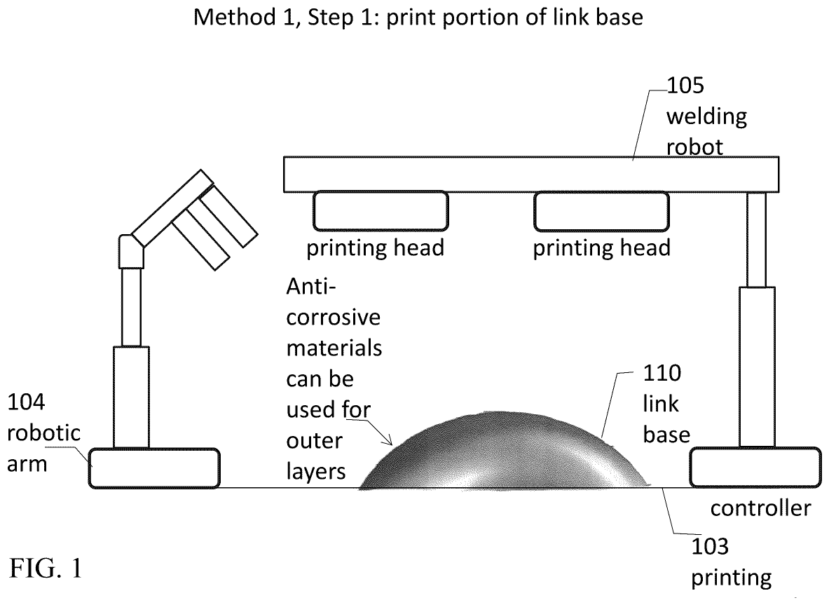

Referring now to FIGS. 1-6, an example method of manufacturing chain links for a marine mooring chain is illustrated. It should be understood that the method illustrated in FIGS. 1-6 is a non-limiting example and in alternate embodiments certain of the steps of FIGS. 1-6 can be combined, performed in parallel, or omitted. FIG. 1 illustrates a work space in which the first step of the example method is performed. FIG. 1 shows a printing platform 103 on which the work is performed. The printing platform can be a stationary platform or a movable conveyor that moves the chain links and their components. Adjacent to the platform 103 are a robotic arm 104 and a welding robot 105. While only a single robotic arm 104 and a single welding robot 105 are shown in FIG. 1 for simplicity, it should be understood that example embodiments can include multiple robotic arms and multiple welding robots.

The robotic arm 104 is used to move completed heavy chain links and components of the heavy chain links as they are formed. The welding robot 105 includes a controller with motors that can move the welding robot 105 into various positions. The controller comprises one or more processors and memory that can store and execute instructions associated with a three-dimensional model of the component that is to be formed. The welding robot 105 carries out the instructions from the controller to deposit layers of material that form the component. The welding robot 105 also includes one or more printing heads that deposit the layers of material to form the component consistent with additive manufacturing techniques. A variety of materials can be used in the layers that the printing heads deposit and can include, as examples, steel, composites, anti-corrosion materials, and components of sensors. Although not shown in FIG. 1 for simplicity, it should be understood that the welding robot 105 can also include other tools used in the forming and finishing of the component, including one or more of welding tools, cutting tools, grinding tools, polishing tools, non-destructive testing tools such as ultrasonic tools, and cameras to monitor the additive manufacturing process to ensure the component is being formed with dimensions specified in the three-dimensional model according to the required quality.

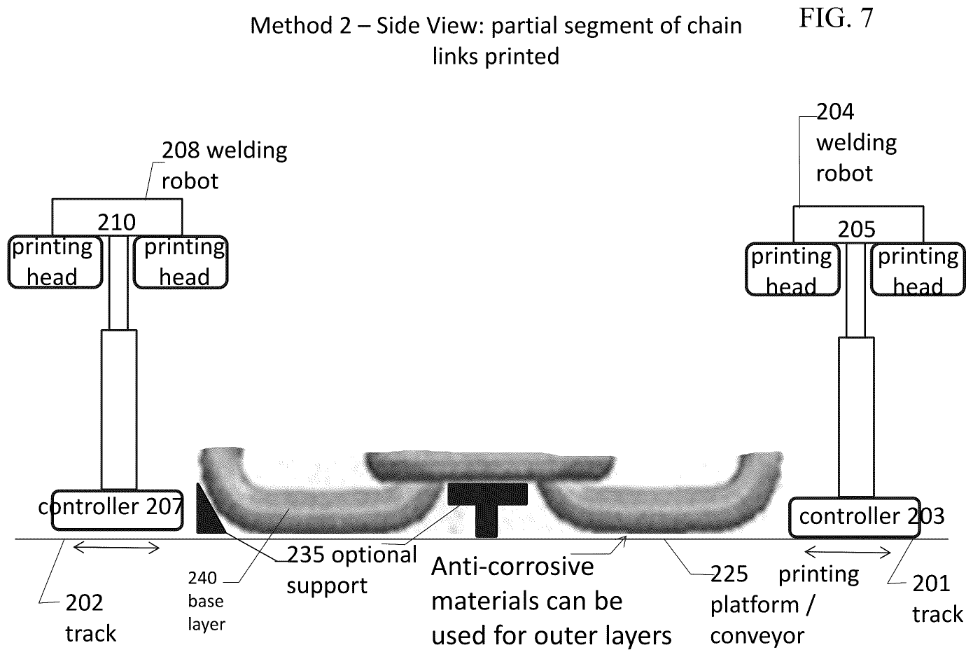

In the example method of FIGS. 1-6, individual chain links are printed and joined together. In contrast, as will be described in the example method of FIGS. 7-9, other additive manufacturing approaches for forming marine mooring chains can involve printing multiple chain links together simultaneously to form a chain segment. Additionally, while the manufacture of chain links are described in connection with the methods illustrated in FIGS. 1-6 and 7-9, it should be understood that those methods also can be adapted to form other components used in a mooring chain segment, such as a shackle, a swivel, a special connector, or a padeye on an anchor.

The method of FIGS. 1-6 begins with printing a portion of a chain link base 110 as illustrated in FIG. 1. Consistent with additive manufacturing techniques, the welding robot 105 deposits layers of steel on the platform to form the link base 110. In an alternate embodiment, the method of FIGS. 1-6 can be modified so that a multitude of link bases are pre-manufactured using additive manufacturing, or other processes such as casting, and the link bases can be used as a “starter” or “seed” to improve the efficiency and/or performance of the overall process of manufacturing chain links. Referring again to FIG. 1, once the link base 110 is formed, the welding robot 105 can deposit an optional anti-corrosive material that is tightly bonded with the steel core, such as an Inconel alloy, on the exterior surface of the link base 110. The anti-corrosive material can protect the chain link against the corrosive effects encountered in the salt water of a marine environment.

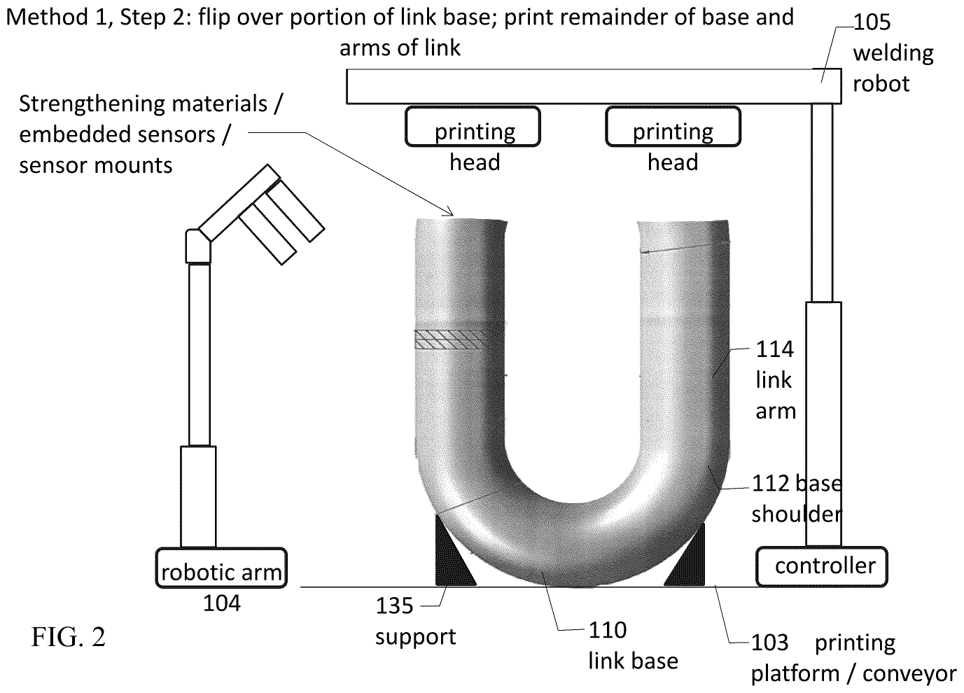

FIG. 2 illustrates the next step of the example method. In FIG. 2, the robotic arm 104 can flip over the portion of the link base 110 formed in FIG. 1 and the welding robot 105 can continue to deposit layers of steel to finish the link base 110 and to form the base shoulders 112 and the arms 114 on each side of the chain link. Given the large size and weight of the chain link for a marine mooring line, supports 135 can be placed around the link base 110. As indicated in FIG. 2, multiple materials can be deposited by the welding robot 105 when forming the chain link so that the chain link has a functional gradient having different properties as varying points of the chain link. A variety of configurations are possible forming functional gradients in the chain link with properties such as strength, hardness, and anti-corrosive characteristics varying at different points on or within the chain link. As one example, steel can be deposited for the portions of the layers forming the interior volume of the chain link, while an anti-corrosive material can be deposited for the portions of the layers forming the exterior surface of the chain link. As another example, if additional strength is desired in areas such as the crowns and shoulders of the chain links, higher strength materials can be deposited for those sections of the chain link. As yet another example, the different properties of the different layers formed in the chain link also can facilitate detection of wear, such as layers with different electrical conductivity or with different colors. The additive manufacturing method also facilitates embedding other components in the chain link as it is formed, such as components for strain gauges, inclinometers, fiber optic sensors, or other sensors. Additionally, mounting points, such as eyelets or flanges, can be formed as the chain link is manufactured to facilitate attachment of gauges or sensors to the chain link.

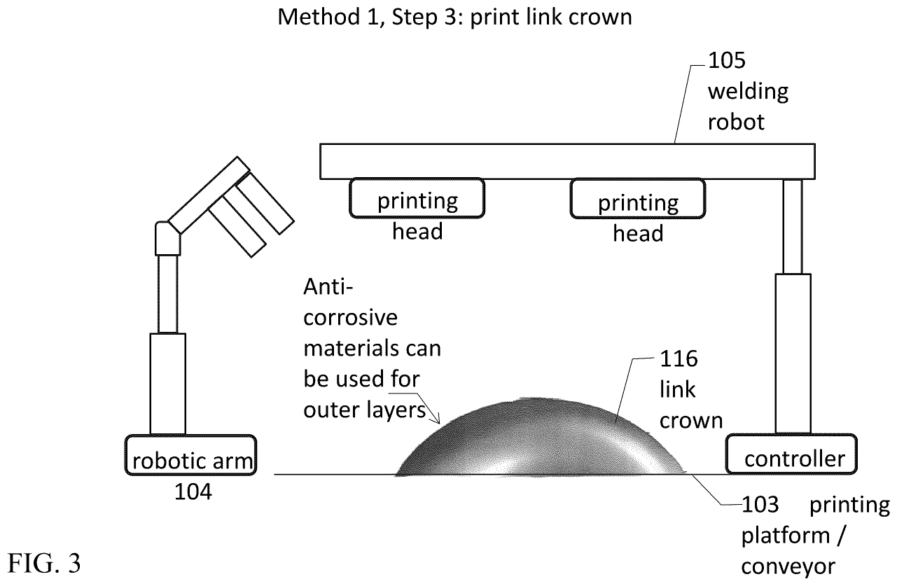

Referring now to FIG. 3, a portion of the link crown is formed. As one example, the robotic arm 104 and/or the conveyor 103 can move the partial chain link shown in FIG. 2 so that the welding robot 105 can begin forming the portion of the crown link 116 shown in FIG. 3. Alternatively, instead of moving the partial chain link shown in FIG. 2, the welding robot 105 can move to a different area on the printing platform/conveyor 103 can begin forming the portion of the crown link 116 shown in FIG. 3. Similar to the additive manufacturing described in connection with FIGS. 1 and 2, in FIG. 3, the welding robot 105 uses one or more printing heads to deposit material on the printing platform 103 to form the portion of the link crown 116. Likewise, as needed, the welding robot can incorporate different materials, such as a first material and a second material, into the portion of the link crown 116.

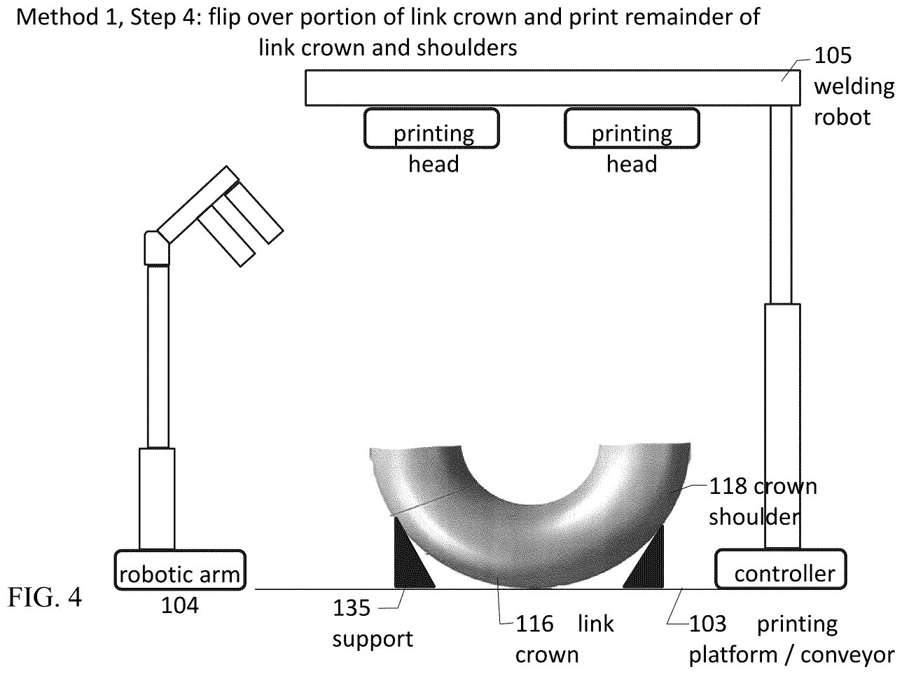

Next, as illustrated in FIG. 4, the robotic arm 104 flips over the portion of the link crown 116 and the welding robot 105 continues forming the remainder of the link crown 116 and the crown shoulders 118 on each side of the link crown. Given the large size and weight of the chain link, supports 135 can be used to stabilize the link crown 116 and the crown shoulders 118.

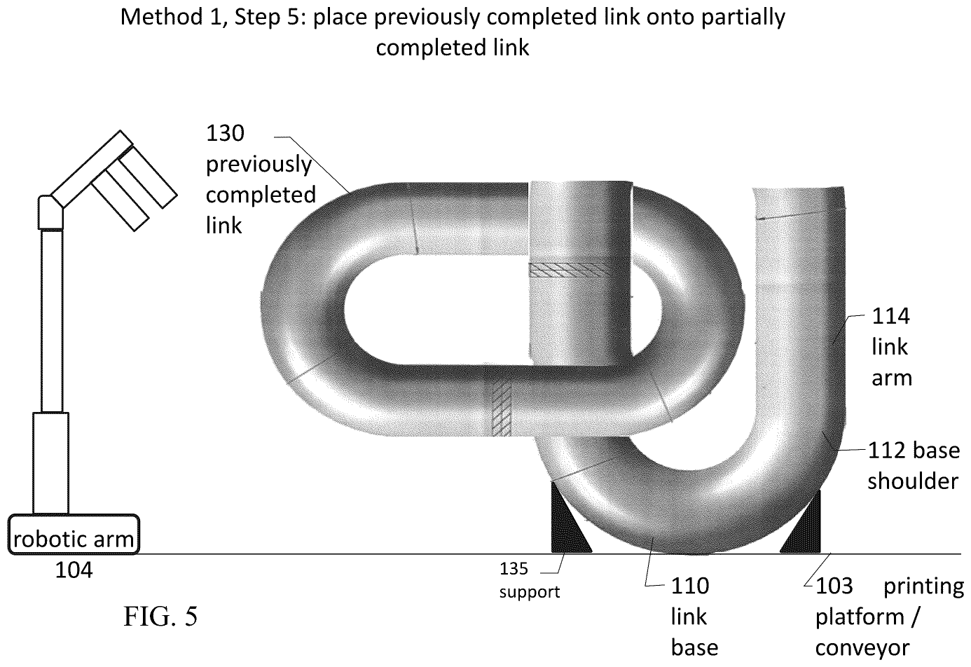

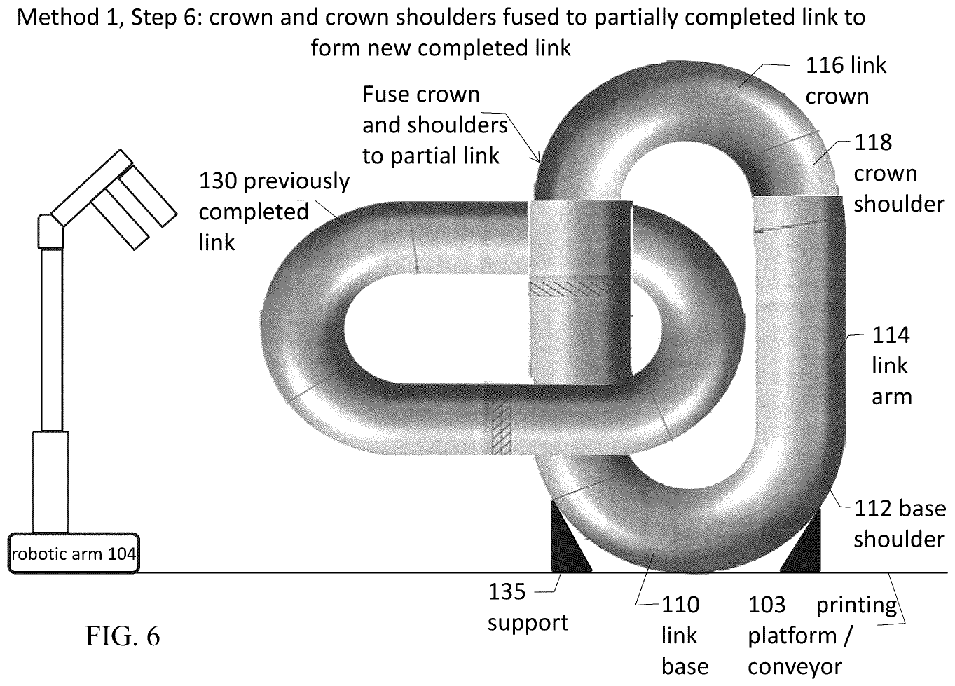

In FIG. 5, the method continues by returning to the portion of the chain link formed in FIG. 2. The robotic arm 104 can retrieve a previously completed chain link 130 and place it onto the portion of the chain link formed in FIG. 2 so that interlocking chain links can be formed. Lastly, in FIG. 6, the component comprising the link crown 116 and crown shoulders 118 formed in FIG. 4 is placed on top of the portion of the chain link illustrated in FIG. 5. When in place, the link crown 116 and crown shoulders 118 can be welded to the portion of the chain link to form a completed chain link with the interlocking previously completed chain link 130. The robotic arm 104 and/or the conveyor 103 can move the two interlocking chain links and the method of FIGS. 1-6 can be repeated to join additional chain links to the two interlocking chain links.

As explained previously, the method of FIGS. 1-6 can be modified as needed to suit particular applications. For example, the steps illustrated in FIGS. 1 and 3 in which the base and the crown of the link are partially formed and then flipped over to continue adding layers of material can be modified such that the portions of the base and crown are formed in an inverted position from that shown in FIGS. 1 and 3, with the assistance of supports, thereby eliminating the need to flip over the portions of the base and crown. As another example, other steps can be incorporated into the method so that other materials can be added to the chain link or other finishing processes, such as grinding and polishing, can be performed.

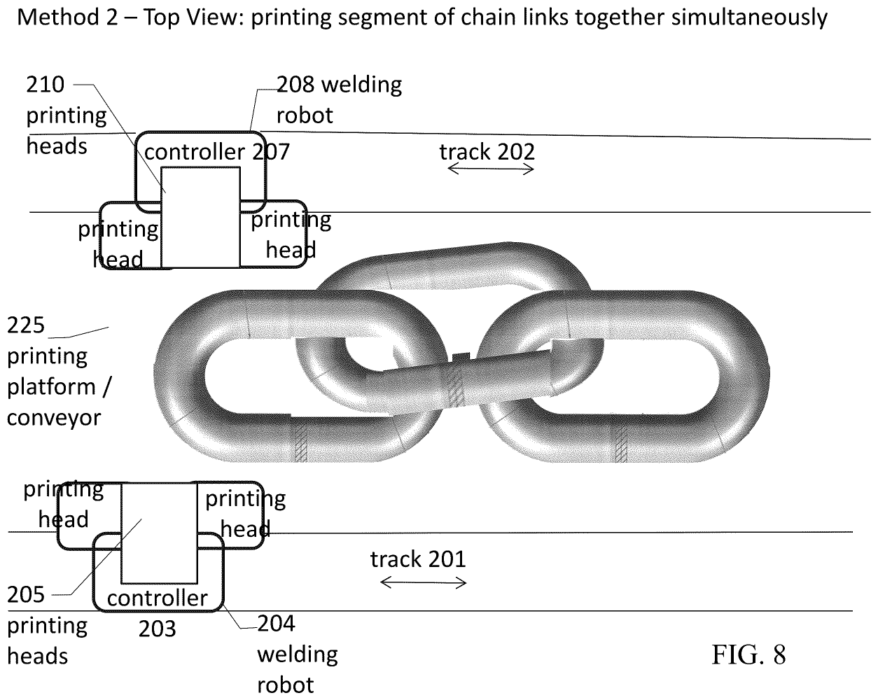

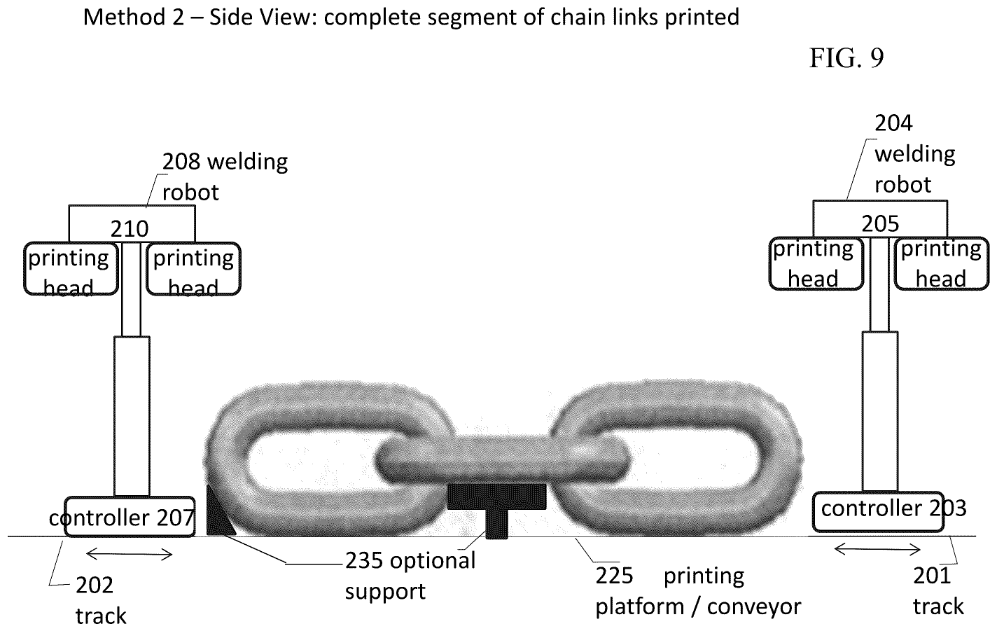

Referring now to FIGS. 7-9, another example method of forming a segment of chain links using additive manufacturing is illustrated. In contrast to the method of FIGS. 1-6 wherein individual chain links are formed by additive manufacturing, the method of FIGS. 7-9 uses additive manufacturing to form a segment of multiple chain links together simultaneously. FIG. 7 shows a side view of the method with the chain links of the chain segment partially formed. FIGS. 8 and 9 show top and side views, respectively, of the completed segment of chain links.

The example method of FIGS. 7-9 employs a first welding robot 204 mounted on a first track 201 and a second welding robot 208 mounted on a second track 202. It should be understood that two welding robots and two tracks are not required and in alternate embodiments a single welding robot can be used or more than two welding robots can be used to form the segment of chain links. The one or more welding robots can be referred to as a robotic printer system. Additionally, although the first track 201 and second track 202 are shown as linear in FIG. 8, it should be understood that in other embodiments the welding robots can move in other directions.

The welding robots 204 and 208 are similar to the welding robot of FIGS. 1-4 in that welding robot 204 comprises a controller 203 with associated motors and welding robot 208 comprises a controller 207 with associated motors. The respective controller and motors that can move each of the welding robots into various positions. The controller and the motors also can move the components of the welding robots. For example, the printing heads can be attached to an extendable arm that extends out over the chain segment as the material for the chain links is deposited. The controller comprises one or more processors and memory that can store and execute instructions associated with a three-dimensional model of the component that is to be formed. The welding robots 204 and 208 carry out the instructions from the controller to deposit layers of material that form the component. The welding robots 204 and 208 also include one or more printing heads that deposit the layers of material to form the component consistent with additive manufacturing techniques. The welding robots 204 and 208 also can include other tools used in the forming and finishing of the chain segment, including one or more of welding tools, cutting tools, grinding tools, polishing tools, non-destructive testing tools such as ultrasonic tools, and cameras to monitor the additive manufacturing process.

As illustrated in FIG. 7, the method of FIGS. 7-9 uses an additive manufacturing process to deposit layers of material for multiple chain links together simultaneously. The chain links are assembled so that each chain link is interlocking with adjacent chain links and each chain link is positioned in a lengthwise orientation so that the longitudinal axes of symmetry of the chain links are oriented in approximately the same direction. FIG. 7 shows the welding robots 204 and 208 can be moved along the printing platform 225 to deposit material forming a base layer 240 of the chain segment. As one example, the controller and motors can move the welding robots 204 and 208 back and forth along the tracks 201 and 202 to deposit several layers of material. As the welding robots move along the tracks, the controller and motors can move the arm on which the printing heads are mounted to extend them out over the printing platform 225 in order to deposit material in the appropriate locations to form the base layer 240 of the chain links. The base layer can be a single material such as aluminum or another material having anti-corrosive properties. Alternatively, the base layer 240 can comprise multiple materials, such as a steel core for the interior volumes of the chain links and an anti-corrosive material for the portions that make up the external surfaces of the chain links. As other examples, other materials that can be deposited by the printing heads of the welding robots include materials that enhance the tensile strength, toughness, or hardness of the chain links. As yet another example, materials having different physical properties, such as conductivity or color, the facilitate detection of wear in the chain can be deposited in layers in the chain. In other example embodiments, materials that form sensors, such as strain gauges, inclinometers or fiber optic components, or mounting points for such components, can be deposited by the printing heads. As also illustrated in FIG. 7, supports 235 can be placed where needed to support the segment of chain links given that the chain links for a marine mooring line can be up to two feet long and can weigh several hundred pounds.

Referring to FIGS. 8 and 9, after the welding robots 204 and 208 deposit the base layer 240, the welding robots can continue to move back and forth on the tracks 201 and 202 to deposit additional layers of material. Each successive layer can comprise a single material or multiple materials. As one example, the printing heads can deposit a second layer comprising steel on top of the base layer 240. Alternatively, the second layer can comprise multiple materials wherein material making up the interior volume of each chain link is steel and material that forms the exterior surfaces of the chain links is aluminum or another material having anti-corrosive properties. The second layer can be followed by a third layer, which may be the final layer, deposited by the printing heads of each welding robot. As with the previous layers, the third layer can comprise a single material or multiple materials. The completed segment of interlocked chain links can be seen in FIGS. 8 and 9. Three completed chain links are illustrated for simplicity, but can be expanded to add other chain links as part of the additive manufacturing process. Additionally, the controllers of the welding robots can process other instructions to include additional components such as a shackle or swivel with the segment of chain links.

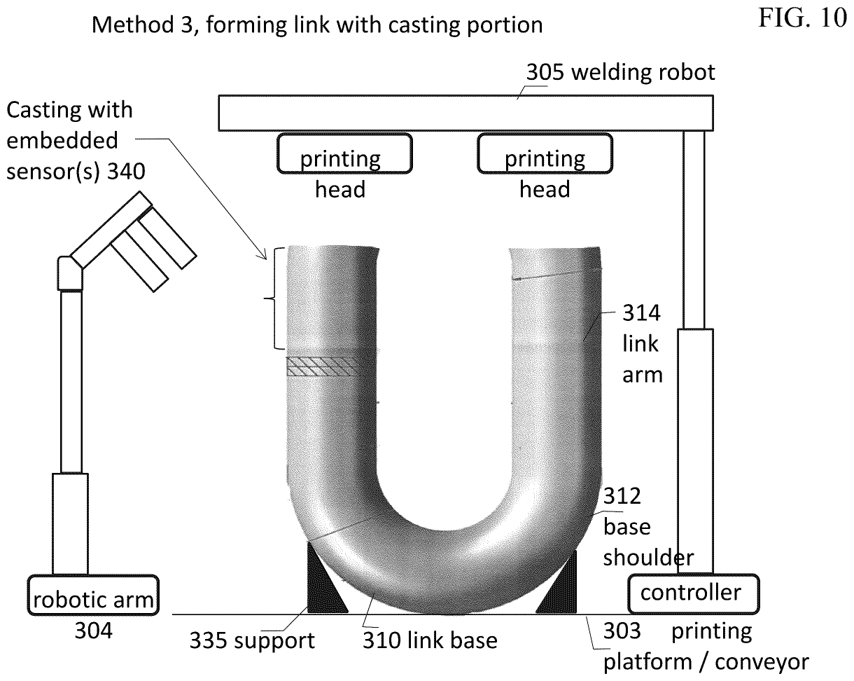

Referring to FIG. 10, an alternate embodiment that is a variation of the method of FIGS. 1-6 is illustrated. The alternate embodiment shown in FIG. 10 generally employs the same steps as described in FIGS. 1-6, except that a component of the chain link is a casting portion that is formed separately before it is incorporated into the chain link. As used herein, a casting portion refers to any portion of a chain link that is formed separately prior to forming the chain link. Moreover, as used herein, a casting portion refers to any process used to make such pre-formed portion, including casting, forging, machining, and additive manufacturing. As illustrated in FIG. 10, the system includes a printing platform 303 on which the work is performed. Adjacent to the printing platform are a robotic arm 304 and a welding robot 305, similar to the robotic arm and welding robot previously described. As in the previous examples, the welding robot 305 carries out instructions from the controller to deposit layers of material to form a first portion of the chain link. In the example of FIG. 10, the first portion can include one or more of the link base 310, the base shoulder 312, the link arm 314, or another component of the chain link.

The example of FIG. 10 differs from the previous examples in that a casting portion 340 is incorporated into the chain link as it is formed. The robotic arm 304 can position the casting portion 340 onto the existing portion of the chain link and the welding robot 305 can fuse the casting portion 340 and the first portion of the chain link together. The welding robot 305 can then continue forming the remainder of the chain link using the additive manufacturing techniques described herein. The casting portion 340 can be made of one or more of a variety of metallic materials using known casting, forging, machining, or additive manufacturing techniques for such materials. An advantage of the casting portion is that it can include components such as sensors or mounting points that will be integrated into the finished chain link. While the casting portion 340 is illustrated as a portion of the link arm in FIG. 10, one or more casting portions can be integrated into any portion of the chain link. As in the example of FIGS. 1-6, a previously completed link can be placed onto the partially formed link illustrated in FIG. 10 before the partially formed link is completed in order to form a chain segment of multiple chain links.

Given the option to use multiple materials with each layer that is deposited by the printing heads, the final chain links can have a functional gradient wherein one or more properties of the chain links vary at different points of the chain link. For example, the anti-corrosive property of each chain link may be greater along the exterior surfaces of the chain links relative to the interior volumes. As another example, the hardness of each chain link may be greater along the exterior surfaces of the chain links relative to their interior volumes if abrasion of the chain links is a concern. The additive manufacturing process allows for the customization of marine mooring chains for a variety of environmental conditions.

The techniques described herein also can be applied in hybrid approach. In one aspect, chain links can be manufactured using the conventional approach of heating, bending, and welding a bar of steel into a chain link. One the chain link is formed by the conventional approach, the additive manufacturing methods described herein can be used to apply additional material to the chain link. The additional material can take a variety of forms such as a corrosion-resistant or wear-resistant material that protects the chain link. As another example, the additional material applied by additive manufacturing can form a sensor on a portion of the chain link. As another example, the additive manufacturing techniques described herein can be used to repair a chain link that has been experienced corrosion or wear. Accordingly, it should be understood that the techniques described herein can be used to improve chain links in a variety of ways.

### Assumptions and Definitions

For any figure shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Terms such as “first” and “second” are used merely to distinguish one element (or state of an element) from another. Such terms are not meant to denote a preference and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a,” “an,” and “the” are intended to include plural alternatives, e.g., at least one. The terms “including”, “with”, and “having”, as used herein, are defined as comprising (i.e., open language), unless specified otherwise.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, +5% of the stated value, ±3% of the stated value, or ±1% of the stated value.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A method of forming a marine mooring chain using an additive manufacturing process, the method comprising:
forming, by the additive manufacturing process, a portion of a base of a first chain link;
turning over the portion of the base and placing one or more supports about the portion of the base;
forming, by the additive manufacturing process, a remainder of the base and a pair of arms of the first chain link, thereby producing a partial first chain link;
forming, by the additive manufacturing process, a portion of a crown;
turning over the portion of the crown and placing one or more supports about the portion of the crown;
forming, by the additive manufacturing process, a remainder of the crown and a pair of crown shoulders, thereby producing a crown assembly;
placing a previously completed chain link onto the partial first chain link; and
fusing the crown assembly onto the partial first chain link, thereby producing a pair of interlocked chain links of the marine mooring chain.

2. The method of claim 1, wherein the additive manufacturing process uses a first material and a second material to form the first chain link, wherein the first material has a different property relative to the second material, and wherein the different property is one or more of: tensile strength, toughness, hardness, corrosion resistance, electrical conductivity, and color.

3. The method of claim 2, wherein the first material is disposed in an interior volume of the first chain link and wherein the second material is disposed along an exterior surface of the first chain link.

4. The method of claim 1, further comprising forming on the first chain link one or more sensor mounting points for attaching one or more sensors.

5. The method of claim 1, wherein one or more sensors are embedded in the first chain link during the additive manufacturing process.

6. (canceled)

7. (canceled)

8. (canceled)

9. (canceled)

10. (canceled)

11. A method of forming a marine mooring chain using an additive manufacturing process, the method comprising:
printing, with a robotic printer system, a base layer of a chain segment comprising multiple chain links, wherein the multiple chain links of the chain segment are interlocked and laying lengthwise on a platform, and wherein the base layer comprises a first material;
printing, with the robotic printer system, a second layer of the chain segment comprising multiple chain links, wherein the second layer comprises a second material; and
printing, with the robotic printer system, a third layer of the chain segment comprising multiple chain links, wherein the third layer comprises the first material.

12. The method of claim 11, wherein the first material has a different property relative to the second material, and wherein the different property is one or more of: tensile strength, toughness, hardness, corrosion resistance, electrical conductivity, and color.

13. The method of claim 12, wherein the second material is disposed in an interior volume of the multiple chain links of the chain segment and wherein the first material is disposed along an exterior surface of the multiple chain links of the chain segment.

14. The method of claim 11, further comprising forming on the chain segment one or more sensor mounting points for attaching one or more sensors.

15. The method of claim 11, wherein one or more sensors are embedded in at least one of the multiple chain links of the chain segment during the additive manufacturing process.

16. (canceled)

17. (canceled)

18. (canceled)

19. (canceled)

20. (canceled)

21. A method of forming a marine mooring chain using an additive manufacturing process, the method comprising:
forming, by the additive manufacturing process, a first portion of a chain link by depositing and fusing chain link material using a welding robot comprising a printing head; and
fusing a casting portion to the first portion of the chain link, the casting portion comprising at least one of a sensor and a sensor mounting point,
wherein the first portion and the casting portion form the chain link.

22. The method of claim 21, wherein the casting portion forms one of a base, a crown, a shoulder, or an arm of the chain link.

23. The method of claim 21, further comprising placing a previously completed chain link onto the first portion of the chain link before fusing the casting portion to the first portion of the chain link.

24. (canceled)

25. (canceled)

26. (canceled)
